(19) United States
(12) Patent Application Publication
(10) Pub. No.: US 2007/0030222 A1
(43) Pub. Date: Feb. 8, 2007

(54) Display device and driving method thereof

(76) Inventors: Joo-Hyung Lee, Gwacheon-si (KR); Hyung-Guel Kim, Yongin-si (KR)

Correspondence Address: CANTOR COLBURN, LLP, 55 GRIFFIN ROAD SOUTH, BLOOMFIELD, CT, 06002, US

(21) Appl. No.: 11/501,122

(22) Filed: Aug. 8, 2006

(30) Foreign Application Priority Data
Aug. 8, 2005 (KR) 10-2005-0072233

(51) Int. Cl. G09G 3/36

(52) U.S. Cl. 345/87

(57) ABSTRACT

The present invention relates to a display device including a display panel divided into an edge region and first and second display areas, first and second pixels respectively formed at the first and second display areas, a light source irradiating light on the display panel, optical sensors formed at the edge region or the first display area and receiving external light to generate sensing signals corresponding to luminance of the external light, a sensing signal processor determining a current condition of luminance based on the sensing signals to generate luminance control signals, and a light source controller controlling luminance of the light source according to the luminance control signals. Thus, power consumption of the display device is reduced by controlling luminance of the light source.

This application claims priority to Korean Patent Application No. 10-2005-0072233, filed on Aug. 08, 2005 and all the benefits accruing therefrom under 35 U.S.C. §119, and the contents of which in its entirety are herein incorporated by reference.

### BACKGROUND OF THE INVENTION

(a) Field of the Invention

The present invention relates to a display device and a driving method thereof, and more particularly, to a transflective liquid crystal display (“LCD”) and a driving method thereof.

(b) Description of the Related Art

In general, a liquid crystal display (“LCD”) includes two display panels, having pixel electrodes and a common electrode, and a liquid crystal layer interposed between the two display panels and having dielectric anisotropy. The pixel electrodes are arranged in a matrix on one of the display panels and are connected to switching elements, such as thin film transistors (“TFTs”), so that a data voltage can be applied to the pixel electrodes row by row. The common electrode is formed on the entire surface of one of the display panels, and a common voltage is applied to the common electrode. From a circuit point of view, the pixel electrode, the common electrode, and the liquid crystal layer interposed therebetween form a liquid crystal capacitor, and the liquid crystal capacitor and the switching element connected thereto become a base unit forming a pixel.

In the LCD, a voltage is applied to the pixel and common electrodes so as to generate an electric field in the liquid crystal layer, and the transmittance of light passing through the liquid crystal layer is adjusted by adjusting the intensity of the electric field, thereby obtaining a desired image.

Since the LCD is a light-receiving display device incapable of emitting light itself, the LCD causes light emitted from a lamp of a separately provided backlight to be transmitted through the liquid crystal layer, or causes external light such as natural light to be transmitted through the liquid crystal layer before reflecting the light to again transmit it through the liquid crystal layer. The former is called a transmissive LCD, the latter is called a reflective LCD, and the latter LCD is used in a medium-sized display device. Further, a transflective LCD or a reflective-transmissive LCD using backlight or external light depending on circumstances has been developed to be mainly used in a mid-sized display device.

Further, mid-sized LCDs, such as on a mobile phone and a notebook PC, are portable devices. Accordingly, reducing power consumption promotes longer hours of use and mobility.

### BRIEF SUMMARY OF THE INVENTION

The present invention provides a display device capable of reducing power consumption, and a driving method thereof.

According to exemplary embodiments of the present invention, a display device includes a display panel divided into an edge region and first and second display areas, a plurality of first and second pixels respectively formed at the first and second display areas, a light source irradiating light on the display panel, a plurality of optical sensors formed at the edge region or the first display area and receiving external light to generate sensing signals corresponding to luminance of the external light, a sensing signal processor determining a current condition of luminance based on the sensing signals to generate luminance control signals, and a light source controller controlling luminance of the light source according to the luminance control signals. The first and second pixels include first and second pixel electrodes, respectively, and the first pixel electrode is larger than the second pixel electrode.

The first pixel electrode includes a transparent electrode and a reflecting electrode, and at least one of the optical sensors may be formed below the reflecting electrode.

The display device may further include a light blocking member formed at the edge region, and at least one of the optical sensors may be formed below the light blocking member.

Each optical sensor may include an optical sensing element formed of a TFT and generating one of the sensing signals.

The optical sensor may further include a switching element formed of a thin film transistor and outputting one of the sensing signals.

The first pixel electrode may be three times or more larger than the second pixel electrode.

The sensing signal processor processes the sensing signals output from the plurality of optical sensing elements, converts the sensing signals to a plurality of digital signals, and determines a condition of luminance corresponding to digital signals having a same value as the current condition of luminance when a number of the digital signals having the same value, among the plurality of digital signals, is more than or same as a predetermined number.

The sensing signal processor can maintain a former condition of luminance as the current condition of luminance when the number of digital signals having the same value, among the plurality of digital signals, is less than the predetermined number.

According to other exemplary embodiments of the present invention, a display device includes a display panel including a plurality of pixels, a light source irradiating light on the display panel, a plurality of optical sensors receiving external light to generate sensing signals corresponding to luminance of the external light, a sensing signal processor processing the sensing signals output from the plurality of optical sensors, converting the sensing signals to a plurality of digital signals, and determining a condition of luminance corresponding to digital signals having a same value as a current condition of luminance when a number of the digital signals having the same value, among the plurality of digital signals, is more than or same as a predetermined number, to generate a luminance control signal, and a light source controller controlling luminance of the light source according to the luminance control signal.

The sensing signal processor may include a switching unit sequentially selecting sensing signals output from the plurality of optical sensors for every predetermined time.

The predetermined time may be at least one frame unit.

The sensing signal processor may include an A/D converter converting the sensing signals to the digital signals, the A/D converter having a hysteresis characteristic.

The A/D converter may include at least one comparator.

According to other exemplary embodiments of the present invention, a driving method of the display device includes generating a plurality of sensing signals by receiving external light, converting the plurality of sensing signals to a plurality of digital signals indicating conditions of luminance based on the plurality of sensing signals, determining a condition of luminance corresponding to digital signals having a same value as a current condition of luminance when a number of the digital signals having the same value, among the plurality of digital signals, is more than or same as a predetermined number, generating a luminance control signal according to the current condition of luminance, and controlling the light source according to the luminance control signal.

The light source may be a light emitting diode.

### BRIEF DESCRIPTION OF THE DRAWINGS

The above and other features and advantages of the present invention will become more apparent by describing exemplary embodiments thereof with reference to the accompanying drawings, in which:

FIG. 1 is a block diagram of an exemplary liquid crystal display (“LCD”) according to an exemplary embodiment of the present invention;

FIG. 2 is an equivalent circuit diagram of one exemplary pixel of the exemplary LCD according to the exemplary embodiment of the present invention;

FIG. 3 is an exploded perspective view of the exemplary LCD according to the exemplary embodiment of the present invention;

FIG. 4 is a drawing showing an exemplary display screen of the exemplary LCD according to the exemplary embodiment of the present invention;

FIG. 5 is a schematic diagram of exemplary pixel electrodes of the exemplary LCD according to the exemplary embodiment of the present invention;

FIG. 6 is a block diagram of an exemplary optical sensing unit and an exemplary sensing signal processor of the exemplary LCD according to the exemplary embodiment of the present invention;

FIG. 7A and FIG. 7B are circuit diagrams of exemplary optical sensors of the exemplary LCD according to the exemplary embodiment of the present invention;

FIG. 8A and FIG. 8B are timing diagrams of exemplary signals to be applied to the exemplary optical sensors shown in FIG. 7A and FIG. 7B, respectively;

FIG. 9 is a circuit diagram of an exemplary signal converter of the exemplary LCD according to the exemplary embodiment of the present invention; and,

FIG. 10 is a graph showing input/output characteristics of the exemplary signal converter shown in FIG. 9.

### DETAILED DESCRIPTION OF THE INVENTION

The present invention will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

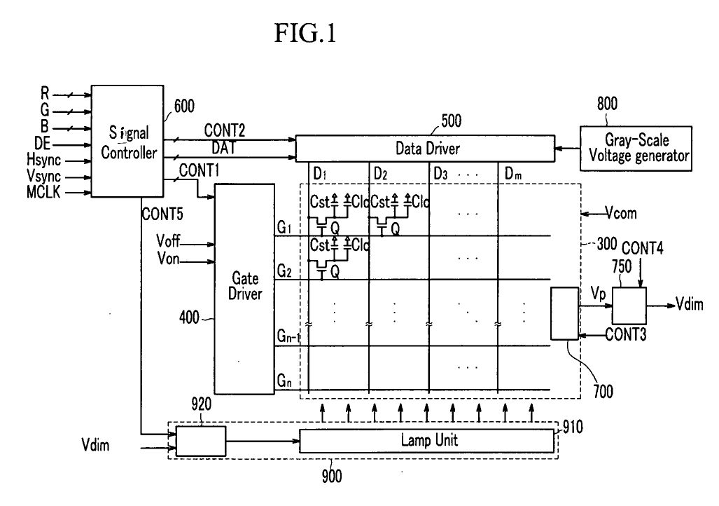

First, a liquid crystal display (“LCD”) according to an exemplary embodiment of the present invention will be described with reference to FIGS. 1 to 5.

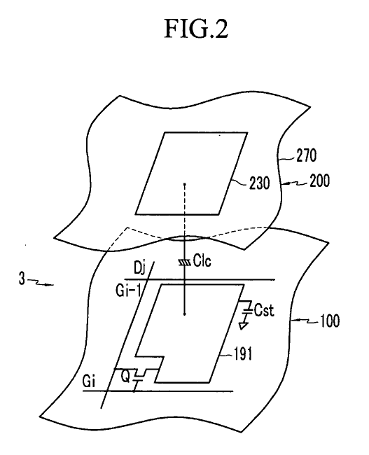

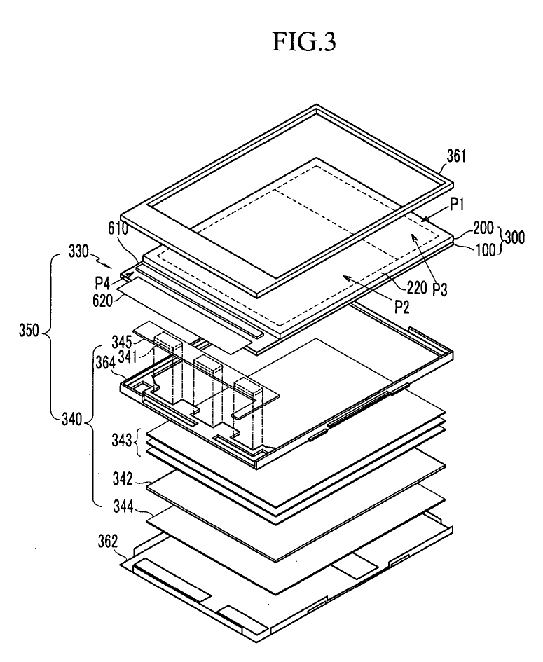

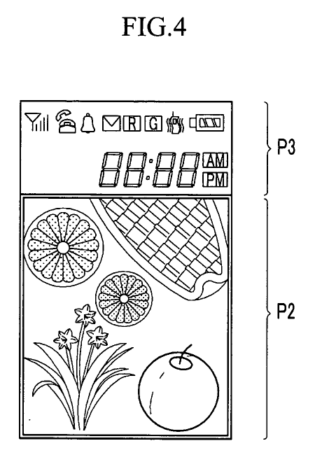

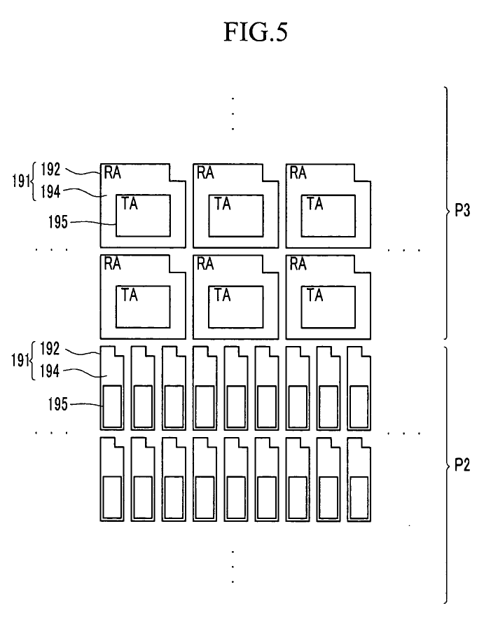

FIG. 1 is a block diagram of the exemplary LCD according to the exemplary embodiment of the present invention, and FIG. 2 is an equivalent circuit diagram of one exemplary pixel of the exemplary LCD according to the exemplary embodiment of the present invention. FIG. 3 is an exploded perspective view of the exemplary LCD according to the exemplary embodiment of the present invention, FIG. 4 is a drawing showing an exemplary display screen of the exemplary LCD according to the exemplary embodiment of the present invention, and FIG. 5 is a schematic diagram of exemplary pixel electrodes of the exemplary LCD according to the exemplary embodiment of the present invention.

As shown in FIG. 1, the LCD includes a liquid crystal panel assembly 300, a gate driver 400 and a data driver 500 connected to the liquid crystal panel assembly 300, a gray-scale voltage generator 800 connected to the data driver 500, a lighting unit 900 that irradiates light on the liquid crystal panel assembly 300, an optical sensing unit 700, a sensing signal processor 750, and a signal controller 600.

From an equivalent circuit point of view, the liquid crystal panel assembly 300 includes a plurality of signal lines G₁ to Gₙ and D₁ to Dₘ, and a plurality of pixels arranged substantially in a matrix and connected to the plurality of signal lines G₁ to Gₙ and D₁ to Dₘ. Further, referring to FIG. 2, the liquid crystal panel assembly 300 includes lower and upper panels 100 and 200, and a liquid crystal layer 3 interposed there between.

The signal lines G₁ to Gₙ and D₁ to Dₘ include a plurality of gate lines G₁ to Gₙ that deliver gate signals (also called “scanning signals”), and a plurality of data lines D₁ to Dₘ that deliver data signals. The gate lines G₁ to Gₙ extend substantially in a row direction, a first direction, and are arranged substantially parallel to each other, and the data lines D₁ to Dₘ extend substantially in a column direction, a second direction substantially perpendicular to the first direction, and are arranged substantially parallel to each other.

Each pixel, for example a pixel connected to i-th (i=1, 2, . . ., n) gate line Gᵢ and j-th (j=1, 2, . . . , m) data line Dⱼ, includes a switching element Q connected to the signal lines Gᵢ and Dⱼ, and a liquid crystal capacitor Clc and a storage capacitor Cst that are connected to the switching element Q. In an alternative embodiment, the storage capacitor Cst can be omitted if necessary.

The switching element Q is a three terminal element, such as a thin film transistor (“TFT”), provided on the lower panel 100. In the switching element Q, a control terminal, such as a gate electrode, is connected to the gate line Gᵢ, an input terminal, such as a source electrode, is connected to the data line Dⱼ, and an output terminal, such as a drain electrode, is connected to the liquid crystal capacitor Clc and storage capacitor Cst.

The liquid crystal capacitor Clc has a pixel electrode 191 on the lower panel 100 and a common electrode 270 on the upper panel 200 as two terminals, and the liquid crystal layer 3 interposed between the electrodes 191 and 270 functions as a dielectric. The pixel electrode 191 is connected to the output terminal of the switching element Q, and the common electrode 270 is formed over the entire surface, or substantially the entire surface, of the upper panel 200 and a common voltage Vcom is applied to the common electrode 270. Unlike in FIG. 2, in an alternative embodiment, the common electrode 270 may be provided on the lower panel 100. In this case, at least one of the two electrodes 191 and 270 can be formed in a line or a rod shape.

The storage capacitor Cst which is subsidiary to the liquid crystal capacitor Clc is formed as a separate signal line (not shown), such as a storage electrode line, provided in the lower panel 100 and the pixel electrode 191 are superimposed on each other with an insulator interposed therebetween, and the separate signal line is applied with a predetermined voltage, such as a common voltage Vcom. However, the storage capacitor Cst is formed as the pixel electrode 191 is superimposed on a previous gate line positioned directly thereon with an insulator as a medium.

Meanwhile, to realize color display, each pixel displays one particular color among a set of main colors (spatial division), or alternately displays the colors on the basis of time (temporal division), so that a desired color is obtained by a summation of the colors on the basis of space and time. For example, the colors are three main colors of red, green, and blue, although the embodiments of the present invention are not limited to such colors. FIG. 2 shows, as an example, the spatial division in which each pixel has a color filter 230 representing one of the colors in a region of the upper panel 200 corresponding to the pixel electrode 191. In an alternative embodiment, the color filter 230 may instead be formed above or below the pixel electrode 191 on the lower panel 100.

At least one polarizer (not shown) that polarizes light is attached to the external surface of the liquid crystal panel assembly 300. For example, a first polarized film and a second polarized film may be disposed on the lower and upper panels 100 and 200 and may adjust a transmission direction of light externally provided into the lower and upper panels 100 and 200 in accordance with an aligned direction of the liquid crystal layer 3. The first and second polarized films may have first and second polarized axes threreof substantially perpendicular to each other.

Returning to FIG. 1, the gray-scale voltage generator 800 generates two pairs of gray-scale voltage groups (or reference gray-scale voltage groups) related to the transmittance of the pixel. One pair has a positive value with respect to the common voltage Vcom, and the other pair has a negative value.

The gate driver 400 is connected to the gate lines G₁ to Gₙ of the liquid crystal panel assembly 300 and applies a gate signal composed of a gate-on voltage Von and a gate-off voltage Voff to the gate lines G₁ to Gₙ.

The data driver 500 is connected to the data lines D₁ to Dₘ of the liquid crystal panel assembly 300, selects a gray-scale voltage from the gray-scale voltage generator 800, and then applies the gray-scale voltage to the data lines D₁ to Dₘ as a data signal. However, when the gray-scale voltage generator 800 does not provide voltages corresponding to all gray levels but rather provides a predetermined number of reference gray-scale voltages, the data driver 500 divides the reference gray-scale voltages so as to generate gray-scale voltages corresponding to all gray levels and selects a data signal among the gray-scale voltages.

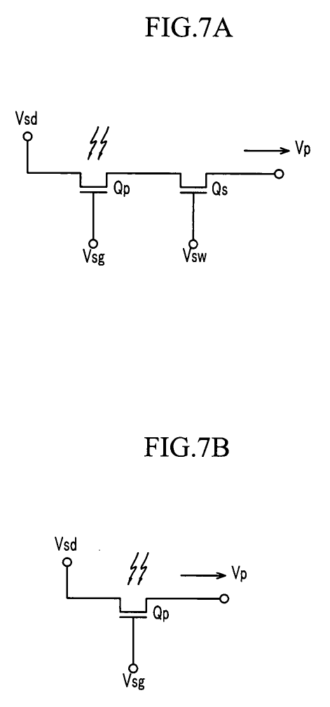

The optical sensing unit 700 includes a plurality of optical sensors (as will be further described below with respect to FIG. 7A and FIG. 7B) that generate a sensing signal Vp corresponding to the luminance of light.

The sensing signal processor 750 receives the sensing signal Vp from the optical sensing unit 700, performs a predetermined signal process, and then generates a luminance control signal Vdim.

The lighting unit 900 includes a lamp unit 910 and a lamp controller 920. The lamp unit 910 includes a plurality of fluorescent lamps or a plurality of light emitting devices such as light emitting diodes (“LEDs”), and the lamp controller 920 controls current flowing to the lamp unit 910 on the basis of the luminance control signal Vdim from the sensing signal processor 750 so as to adjust the intensity of light irradiated from the lamp unit 910 on the liquid crystal panel assembly 300.

The signal controller 600 controls the gate driver 400, data driver 500, optical sensing unit 700, sensing signal processor 750, and lighting unit 900.

Each of the drivers 400, 500, 600, 750, 800, and 920 may be directly mounted on the liquid crystal panel assembly 300 in the form of at least one integrated circuit (“IC”) chip, or mounted on a flexible printed circuit (“FPC”) film (shown in FIG. 3) so as to be attached to the liquid crystal panel assembly 300 in the form of a tape carrier package (“TCP”), or mounted on a separate printed circuit board (“PCB”) (not shown). Otherwise, these drivers 400, 500, 600, 750, 800, and 920 may be directly mounted on the liquid crystal panel assembly 300 together with the signal lines G₁ to Gₙ and D₁ to Dₘ and switching element Q or the like. These drivers 400, 500, 600, 750, 800, and 920 can also be integrated into a single chip. In this case, at least one of them or one circuit element forming these drivers may be disposed outside the single chip.

Meanwhile, as shown in FIG. 3, structurally, the LCD according to the exemplary embodiment of the present invention includes a liquid crystal module 350 having a display unit 330 and a backlight unit 340 that supplies light to the display unit 330, and upper and lower chassis 361 and 362 accommodating the liquid crystal module 350.

The display unit 330 includes the liquid crystal panel assembly 300, an IC 610, and an FPC substrate 620.

Structurally, the liquid crystal panel assembly 300, as shown in FIGS. 2 and 3, includes the lower panel 100 and upper panel 200, the liquid crystal layer 3 interposed therebetween, and a light blocking member 220 defining display areas P2 and P3, where most of the pixels and display signal lines G₁ to Gₙ and D₁ to Dₘ are located inside the display areas P2 and P3. Since the upper panel 200 is smaller than the lower panel 100, a region P4 of the lower panel 100 is exposed on the lower panel 100. In the region P4, the IC 610 is mounted and the FPC substrate 620 is attached.

The IC 610 is formed of a single chip, and includes units for driving the LCD, that is, the gate driver 400, data driver 500, signal controller 600, sensing signal processor 750, gray-scale voltage generator 800, and lamp controller 920.

As these units 400, 500, 600, 750, 800, and 920 are integrated into the IC 610, it is possible to reduce the mounting area as well as power consumption.

However, if necessary, each processing unit or a circuit element used in each processing unit can be disposed outside the IC 610.

The FPC substrate 620 receives a signal from an external device so as to transfer the signal to the IC 610 or the liquid crystal panel assembly 300, and an end of the FPC substrate 620 is generally formed of a connector (not shown) to allow-easy connection with the external device.

The backlight unit 340 includes a lamp unit generating light, a light guide 342 guiding the light from the lamp unit to the display unit 330 in an edge type backlight unit 340, various kinds of optical sheets 343, and a reflector 344.

The lamp unit includes the lamp 341 generating light and the lamp substrate 345 on which the lamp 341 is mounted. The lamp 341, as shown in FIG. 3, may use at least one light emitting element or use at least one fluorescent lamp (not shown), if necessary.

In the case of using the fluorescent lamp, the fluorescent lamp may be disposed on one end or both ends of the light guide 342 in an edge type backlight unit 340, otherwise, it may be disposed below a diffuser (not shown) that replaces the light guide 342 for a direct type backlight unit, and further, a fluorescent lamp formed in an L-shape may be used.

In an edge type backlight unit 340, the light guide 342 is located below the liquid crystal panel assembly 300, is formed in a size corresponding to the liquid crystal panel assembly 300, and guides light by changing a path of light generated by the lamps 341 of the lamp unit so as to supply the light to the liquid crystal panel assembly 300.

Various kinds of optical sheets 343 are disposed on the light guide 342 to make the luminance of the light traveling toward the liquid crystal panel assembly 300 uniform, and a reflector 344 is disposed beneath the light guide 342 to improve efficiency of light by reflecting light leaking from the light guide 342 back toward the liquid crystal panel assembly 300.

The display unit 330 and backlight unit 340 are held by a frame called a mold frame 364, to form the liquid crystal module 350. The display unit 330 is disposed on the mold frame 364 so that its bottom faces the mold frame 364, and the backlight unit 340 is held by the lower chassis 362 disposed therebelow. The upper chassis 361 disposed above the display unit 330 is combined with the mold frame 364 so as to fix the display unit 330 and the backlight unit 340 to the mold frame 364.

As shown in FIG. 4, the display areas P2 and P3 include a main display area P2 that displays still pictures and motion pictures, and a sub-display area P3 that displays predetermined icon information, such as time, residual amount of battery charge, an SMS notice, and the like. Preferably, the predetermined icon information is constantly displayed in the sub-display area P3, regardless of pictures displayed in the main display area P2.

As shown in FIG. 5, each pixel electrode 191 of the display areas P2 and P3 includes a transparent electrode 192 and a reflecting electrode 194 placed thereon. The transparent electrode 192 is made of a transparent conductive material, such as indium tin oxide (“ITO”) or indium zinc oxide (“IZO”), and the reflecting electrode 194 is made of a reflective metal, such as aluminum Al, silver Ag, chromium Cr, or an alloy thereof. The reflecting electrode 194 has a transmitting window 195 that exposes the transparent electrode 192. A light blocking member (not shown) called a black matrix is formed between the respective pixel electrodes 191 so as to prevent light from leaking between the pixel electrodes 191.

Each pixel or pixel region of the transflective LCD can be divided into a transmissive region TA and a reflective region RA that are defined by the transparent electrode 192 and reflecting electrode 194, respectively. That is, a part located below the transmitting window 195 is the transmissive region TA, and a part located below the reflecting electrode 194 is the reflective region RA.

In the transmissive region TA, displaying is performed as light from the backlight unit 340 entering the lower panel 100 (back side) is transmitted through the liquid crystal layer 3 to the upper panel 200 (front side) so as to emanate therefrom. In the reflective region RA, displaying is performed as external light entering the front side enters the liquid crystal layer 3 and is reflected by the reflecting electrode 194 and passed again by the liquid crystal layer 3 so as to exit the front side.

One pixel electrode 191 of the sub-display area P3 is substantially at least three times larger than one pixel electrode 191 of the main display area P2. As shown in FIG. 5, the sub-display area P3 has a pixel resolution that is substantially one third a pixel resolution of the display area P2.

Therefore, while three data lines D₁ to Dₘ make one unit, only one of the three data lines in each unit continuously extends in both the two display areas P2 and P3, and the remaining two data lines in each unit extend only in the main display area P2. However, as the scope of the invention is not limited to such an arrangement, pixel resolution of each of the regions P2 and P3 may differ from the above description, and the data lines D₁ to Dₘ may be differently arranged as well.

The sub-display area P3 has a relatively large reflective region RA, as compared to the main display area P2. Accordingly, even though the predetermined icon information is displayed in the sub-display area P3 for a long time, power consumption can be reduced if operation is performed in a reflective mode that performs display using the reflective region RA.

Hereinafter, the operation of the exemplary LCD will be described.

With reference again to FIG. 1, the signal controller 600 receives an input image signal (R, G, or B) from an external graphics controller (not shown) and an input control signal that controls display of the image. The input image signal (R, G, or B) contains luminance information of each pixel, and luminance has a predetermined number of gray-scale levels, for example 1024 (=2¹⁰), 256 (=2⁸), or 64 (=2⁶) gray-scale levels. The input control signal is, for example, a vertical synchronization signal Vsync, a horizontal synchronizing signal Hsync, a main clock signal MCLK, a data enable signal DE, or the like.

The signal controller 600 appropriately processes the input image signals R, G, and B according to operation conditions of the liquid crystal panel assembly 300 and the data driver 500 on the basis of the input image signals R, G, and B and the input control signal, and generates a gate control signal CONT1, a data control signal CONT2, a sensing control signal CONT3, a sensing data control signal CONT4, and a lamp control signal CONT5, and transfers the gate control signal CONT1 to the gate driver 400, transfers the data control signal CONT2 and a processed image signal DAT to the data driver 500, transfers the sensing control signal CONT3 to the optical sensing unit 700, transfers the sensing data control signal CONT4 to the sensing signal processor 750, and transfers the lamp control signal CONT5 to the lamp controller 920.

The gate control signal CONT1 transferred to the gate driver 400 includes a scanning start signal STV for indicating scanning start and at least one clock signal for controlling the output period of a gate-on voltage Von. The gate control signal CONT1 may further include an output enable signal OE that defines a lasting time of the gate-on voltage Von.

The data control signal CONT2 transferred to the data driver 500 includes a horizontal synchronization start signal STH for notifying of start of transfer of image data with respect to a row of pixels, a load signal LOAD that commands application of a data signal to the data lines D₁ to Dₘ, and the data clock signal HCLK. The data control signal CONT2 may further include an inversion signal RVS that reverses the voltage polarity of the data signal with respect to the common voltage Vcom (hereinafter, “voltage polarity of data signal with respect to common voltage Vcom” is abbreviated to “polarity of data signal”).

According to the data control signal CONT2 from the signal controller 600, the data driver 500 receives a digital image signal DAT with respect to a row of pixels, converts the digital image signal DAT into an analog data signal by selecting a gray-scale voltage from the gray-scale voltage generator 800 corresponding to each digital image signal DAT, and then applies the converted analog data signal to the data lines D₁ to Dₘ.

The gate driver 400 applies the gate-on voltage Von to the gate lines G₁ to Gₙ, according to the gate control signal CONT1 from the signal controller 600, so as to turn on a switching element Q connected to the gate lines G₁ to Gₙ. Accordingly, a data signal data applied on the lines D₁ to Dₘ is applied to the corresponding pixel through the turned-on switching element Q.

The difference between the data voltage applied to a pixel and the common voltage Vcom is indicated by a charge voltage of a liquid crystal capacitor Clc, that is, a pixel voltage. Liquid crystal molecules within the liquid crystal layer 3 are differently arranged according to the magnitude of the pixel voltage, thereby changing the polarization of light though the liquid crystal layer 3. This change of the polarization is indicated by a transmittance change of light by a polarizer or polarizers attached to the liquid crystal panel assembly 300.

The above-mentioned processes are repeatedly performed every one horizontal period (which is represented as “1H” and is equal to one period of the horizontal synchronizing signal Hsync and the data enable signal DE). In this way, the gate-on voltage Von is sequentially applied to all the gate lines G₁ to Gₙ and the data signals are applied to all the pixels, thereby displaying one frame of an image.

When one frame is terminated, the next frame starts, and the condition of an inversion signal RVS applied to the data driver 500 is controlled such that the polarity of a data signal applied to each pixel PX becomes opposite to the polarity of the former frame (“frame inversion”). At this time, even within one frame, according to the characteristic of the inversion signal RVS, the polarity of a data signal flowing through one data line may be converted (example: row inversion, dot inversion), and the polarity of data signals applied on one pixel row may be different from each other (example: column inversion, dot inversion).

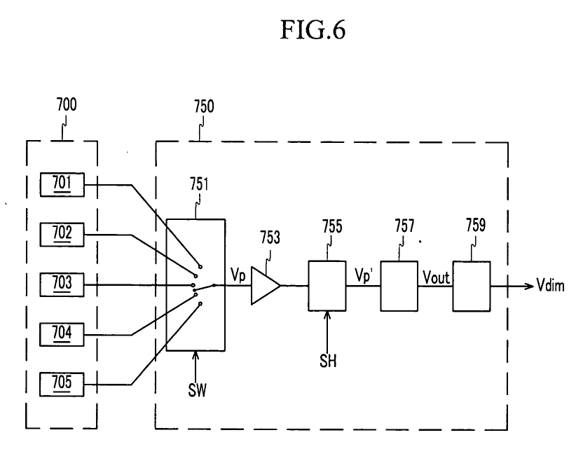

Hereinafter, the exemplary optical sensing unit and exemplary sensing signal processor of the exemplary LCD according to the exemplary embodiment of the present invention will be described in greater detail with reference to FIGS. 6 to 10.

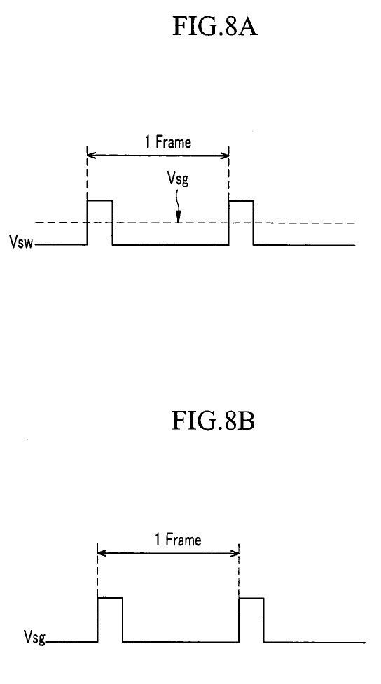

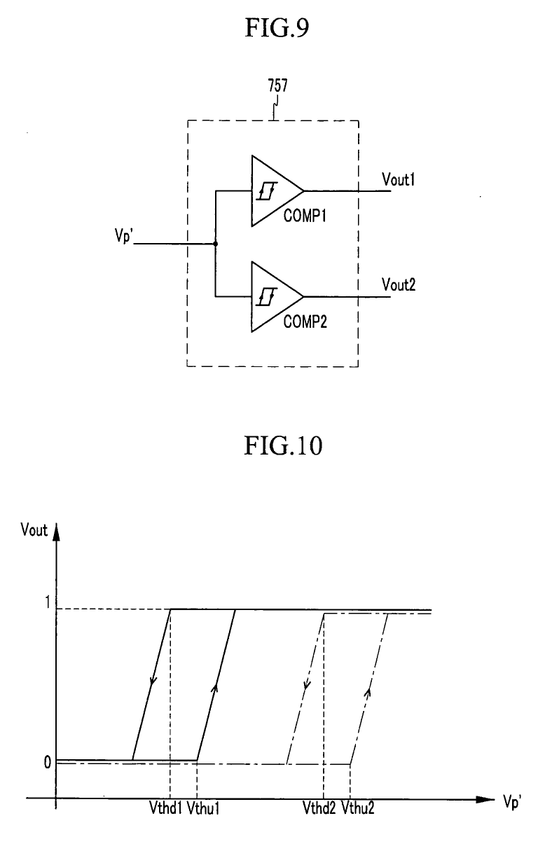

FIG. 6 is a block diagram of the exemplary optical sensing unit and exemplary sensing signal processor of the exemplary LCD according to the exemplary embodiment of the present invention. FIG. 7A and FIG. 7B are equivalent circuit diagrams of exemplary optical sensors of the exemplary LCD according to the exemplary embodiment of the present invention. FIG. 8A and FIG. 8B are timing diagrams of exemplary signals to be applied to the exemplary optical sensors shown in FIG. 7A and FIG. 7B, respectively. FIG. 9 is a circuit diagram of an exemplary signal converter of the exemplary LCD according to the exemplary embodiment of the present invention, and FIG. 10 is a graph showing input/output characteristics of the exemplary signal converter shown in FIG. 9.

As shown in FIG. 6, the optical sensing unit 700 includes five optical sensors 701 to 705. However, the number of optical sensors 701 to 705 is exemplary and not limited to five, and it can be increased and decreased, as necessary. The optical sensing unit 700 receives the sensing control signal CONT3 from the signal controller 600. The sensing signal processor 750 includes a switching unit 751, an amplifier 753, a sample and hold unit 755, a signal converting unit 757, and a calculating unit 759, which are sequentially connected. The sensing signal processor 750 receives the sensing data control signal CONT4 from the signal controller 600. The switching unit 751 of the sensing signal processor 750 is connected to the optical sensors 701 to 705 of the optical sensing unit 700.

As an example of the optical sensing unit 700, as shown in FIG. 7A, each of the optical sensors 701 to 705 includes an optical sensing element Qp and a switching element Qs connected thereto.

The optical sensing element Qp is a three-terminal element, such as a TFT, its control terminal and input terminal are connected to a control voltage Vsg and an input voltage Vsd, respectively, and its output terminal is connected to the switching element Qs. As for the optical sensing element Qp, when light is irradiated on a channel unit semiconductor, the channel unit semiconductor made of amorphous silicon (“a-Si”) or poly crystalline silicon (“polysilicon”) forms an optical current, and the optical current flows in a switching element Qs direction by the input voltage Vsd.

The switching element Qs is also a three-terminal element, such as a TFT, its control terminal and input terminal are connected to an output terminal of a sensing switching signal Vsw and the optical sensing element Qp, respectively, and its output terminal is connected to the sensing signal processor 750. The switching element Qs outputs an optical current to the output terminal as a signal Vp, where the signal Vp is sent to the sensing signal processor 750, when the sensing switching signal Vsw becomes a high voltage, as shown in FIG. 8A, which turns on the switching element Qs.

As further shown in FIG. 8A, the sensing switching signal Vsw becomes a high voltage for every frame, so that the sensing signal processor 750 reads the sensing signal Vp for every frame. Therefore, any one of a scanning start signal STV or a gate signal can be used as a switching signal Vsw. A separate signal can also be used. The value of the control voltage Vsg and input voltage Vsd is set as a DC voltage in consideration of an operation region of the optical sensing element Qp.

In an alternative embodiment, as shown in FIG. 7B, each of the optical sensors 701 to 705 includes an optical sensing element Qp, but not an additional switching element Qs.

The optical sensing element Qp of FIG. 7B is a three terminal element such as a TFT, and its control terminal and input terminal are connected to the control voltage Vsg and the input voltage Vsd, respectively, and its output terminal is connected to the sensing signal processor 750. As shown in FIG. 8B, when the control voltage Vsg becomes a high voltage while light is irradiated on the channel unit semiconductor of the optical sensing element Qp, the channel unit semiconductor made of a-Si or polysilicon forms an optical current, and the optical sensing element Qp outputs the optical current as the sensing signal Vp to the output terminal.

Unlike the control voltage Vsg of FIG. 8A, here, the control voltage Vsg becomes a high voltage for every frame, so that the sensing signal processor 750 reads the sensing signal Vp for every frame. High voltage and low voltage of the control voltage Vsg is set with the value in consideration of an operation region of the optical sensing element Qp.

The optical sensing unit 700 may be integrated with the liquid crystal panel assembly 300 together with the signal lines G₁ to Gₙ and D₁ to Dₘ and the switching element Q or the like, and may be formed below the edge region P1 of the liquid crystal panel assembly 300 or below the reflecting electrode 194 of the sub-display area P3 (shown in FIG. 3). An opening is formed at the light blocking member 220 in the edge region P1 or at the reflecting electrode 194 exposing an upper part of the channel unit of the optical sensing element Qp, so that external light can enter the channel unit of the optical sensing element Qp. In this way, when the optical sensing element Qp is formed, the transmissive region TA of the main display area P2 and of the sub-display area P3 is not decreased, which prevents the luminance of the transmittance mode from decreasing.

The switching unit 751 of the sensing signal processor 750 receives sensing signals Vp from each of the optical sensors 701 to 705 of the optical sensing unit 700, and then outputs one of the sensing signals Vp to the amplifier 753 according to switching signals SW of the signal controller 600, which may form part of the sensing data control signals CONT4. The switching signal SW sequentially selects one of the optical sensors 701 to 705 for a predetermined time unit. The predetermined time unit may be one frame or more. Therefore, the switching unit 751 sequentially outputs each sensing signal Vp from the optical sensors 701 to 705 for every predetermined time unit.

The amplifier 753 outputs the sensing signal Vp from the switching unit 751 to the sample and hold unit 755 after amplifying and filtering the sensing signal Vp to an appropriate signal level.

The sample and hold unit 755 appropriately extracts signals from the amplifier 753 according to a sample holding signal SH from the signal controller 600, which may also form part of the sensing data control signals CONT4, so as to output analog sensing signals Vp′ to the signal converting unit 757.

As shown in FIG. 9, the signal converting unit 757 includes two comparators COMP1 and COMP2, and it receives an analog sensing signal Vp′ extracted from the sample and hold unit 755 and then converts the analog sensing signal to a digital signal Vout. The comparators COMP1 and COMP1 output a value of “0” or “1” according to the signal level of the input analog sensing signal Vp′. As shown in FIG. 10, the comparator COMP1 has a hysteresis characteristic, which helps the comparator offer resistance to change from a previous state, in which the comparator outputs “1” when the sensing signal Vp′ is more than a threshold voltage Vthu1, and outputs “0” when the sensing signal Vp′ is less than the threshold voltage Vthd1. Similarly, the comparator COMP2 also has a hysteresis characteristic in which the comparator outputs “1” when the sensing signal Vp′ is more than a threshold voltage Vthu2, and outputs “0” when the sensing signal Vp′ is less than the threshold voltage Vthd2. Since the comparators COMP1 and COMP2 have the hysteresis characteristic, a digital signal Vout does not frequently change even when the sensing signal Vp′ frequently changes in the vicinity of the threshold voltages Vthu1, Vthd1, Vthu2, and Vthd2. Accordingly, a luminance control signal Vdim output from the sensing signal processor 750 does not frequently change, thereby preventing frequent luminance changes of the lamp unit 910. The threshold voltages Vthu1, Vthd1, Vthu2, and Vthd2 are set on the basis of the intensity of external light and the analog sensing signal Vp′ corresponding to the intensity of external light.

The signal converting unit 757 transfers a digital signal Vout indicating the three kinds of luminance “00”, “01”, and “10” to the calculating unit 759, according to each of the digital output signals Vout1 and Vout2 of the comparators COMP1 and COMP2. When the digital signal Vout is “00”, the digital signal represents a dark condition like a dark chamber or darkroom, when the digital signal Vout is “01”, the digital signal represents a moderately bright condition like a bright chamber, and when the digital signal Vout is “10”, the digital signal represents an extremely bright condition like a field. For example, the intensity of reference external light for dividing the three kinds of luminance can be set to 50 lux and 2000 lux.

Although two comparators COMP1 and COMP2 are shown in FIG. 9, the signal converting unit 757 may instead include one comparator or three or more comparators if necessary, and the kinds of luminance can be changed in number accordingly. In an alternative embodiment, the signal converting unit 757 may have an A/D converter (not shown) instead of a comparator so as to convert an analog sensing signal Vp′ to a digital output signal Vout. Here, it is preferable that the A/D converter has a hysteresis characteristic.

The calculating unit 759 sequentially receives five digital signals Vout corresponding to the sensing signals Vp of each of the optical sensors 701 to 705 for every predetermined time unit, so as to store the digital signals Vout in a storage element (not shown). When the five digital signals Vout are stored in the storage element, the calculating unit 759 determines the current condition of luminance with reference to the five stored digital signals Vout, and determines a condition such that, for example, at least three equal digital signals Vout, among the five digital signals Vout, indicate the current condition of luminance. When less than three digital signals Vout agree with each other, the former condition of luminance is maintained. Even if the number of optical sensors is other than five, the calculating unit 759 determines a condition in which more than a predetermined number of equal digital signals indicate the current condition of luminance, and any number less than the predetermined number indicates that the former condition of luminance is to be maintained.

Because of semiconductor characteristics, it is unlikely that all of the optical sensors 701 to 705 made of TFTs output the same sensing signals Vp with respect to equal luminance of external light. Therefore, it is difficult to accurately determine the current condition of luminance with only one optical sensor. However, in the present invention, it is possible to accurately determine the current condition of luminance since the plurality of optical sensors 701 to 705 are provided to determine a condition of luminance that a majority of optical sensors indicate as the current condition of luminance. Even if some of the optical sensors 701 to 705 do not function well, it is still possible to determine the condition of luminance by using the rest of the optical sensors.

The calculating unit 759 determines the current condition of luminance, changes or maintains the level or condition of the luminance control signal Vdim accordingly, and outputs the luminance control signal Vdim to the lamp controller 920. The luminance control signal Vdim is set such that the lamp unit 910 is turned off when the current condition of luminance indicates extremely bright, the lamp unit 910 irradiates light with moderate luminance when the current condition of luminance indicates moderately bright, and the lamp unit 910 irradiates light with high luminance when the current condition of luminance indicates extremely dark. The lamp controller 920 controls a current flowing through the lamp unit 910 accordingly, to adjust intensity of light irradiated on the liquid crystal panel assembly 300.in line with the current condition of luminance.

Even though the optical sensing unit 700 is disposed in the LCD to control luminance in the exemplary embodiment of the present invention, the application of the present invention is not limited to the exemplary embodiment, and the optical sensing unit 700 can be disposed in other types of light-receiving display devices including a backlight unit to thereby control the luminance of the backlight unit.

As such, according to the present invention, it is possible to reduce power consumption of a transflective LCD that is capable of division display by controlling luminance of a lamp of the backlight unit on the basis of sensing signals from the plurality of optical sensors.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a display panel divided into an edge region and first and second display areas; p1 a plurality of first and second pixels respectively formed at the first and second display areas;
a light source irradiating light on the display panel;
a plurality of optical sensors formed at the edge region or the first display area and receiving external light to generate sensing signals corresponding to luminance of the external light;
a sensing signal processor determining a current condition of luminance based on the sensing signals to generate luminance control signals; and
a light source controller controlling luminance of the light source according to the luminance control signals,
wherein the first and second pixels include first and second pixel electrodes, respectively, and the first pixel electrode is larger than the second pixel electrode.

2. The display device of claim 1,
wherein the first pixel electrode includes a transparent electrode and a reflecting electrode, and
at least one of the optical sensors is formed below the reflecting electrode.

3. The display device of claim 1, further comprising a light blocking member formed at the edge region, wherein at least one of the optical sensors is formed below the light blocking member.

4. The display device of claim 1, wherein each optical sensor includes an optical sensing element generating one of the sensing signals, the optical sensing element formed of a thin film transistor.

5. The display device of claim 4, wherein each optical sensor further includes a switching element outputting one of the sensing signals, the switching element formed of a thin film transistor.

6. The display device of claim 1, wherein the first pixel electrodes are three times or more larger than the second pixel electrodes.

7. The display device of claim 1, wherein the sensing signal processor processes the sensing signals output from the plurality of optical sensing elements, converts the sensing signals to a plurality of digital signals, and determines a condition of luminance corresponding to digital signals having a same value as the current condition of luminance when a number of the digital signals having the same value, among the plurality of digital signals, is more than or same as a predetermined number.

8. The display device of claim 7, wherein the sensing signal processor maintains a former condition of luminance as the current condition of luminance when the number of digital signals having the same value, among the plurality of digital signals, is less than the predetermined number.

9. The display device of claim 1, wherein the light source is a light emitting diode.

10. A display device comprising:
a display panel including a plurality of pixels;
a light source irradiating light on the display panel;
a plurality of optical sensors receiving external light to generate sensing signals corresponding to luminance of the external light;
a sensing signal processor processing the sensing signals output from the plurality of optical sensors, converting the sensing signals to a plurality of digital signals, and determining a condition of luminance corresponding to digital signals having a same value as a current condition of luminance when a number of the digital signals having the same value, among the plurality of digital signals, is more than or same as a predetermined number, to generate a luminance control signal; and
a light source controller controlling luminance of the light source according to the luminance control signal.

11. The display device of claim 10, wherein a former condition of luminance is maintained as the current condition of luminance when the number of digital signals having the same value, among the plurality of digital signals, is less than the predetermined number.

12. The display device of claim 10, wherein the sensing signal processor includes a switching unit sequentially selecting sensing signals output from the plurality of optical sensors for every predetermined time.

13. The display device of claim 12, wherein the predetermined time is at least one frame unit.

14. The display device of claim 10, wherein the sensing signal processor includes an A/D converter converting the sensing signals to the digital signals, the A/D converter having a hysteresis characteristic.

15. The display device of claim 14, wherein the A/D converter includes at least one comparator.

16. The display device of claim 10, wherein each optical sensor includes an optical sensing element generating one of the sensing signals, the optical sensing element formed of a thin film transistor.

17. The display device of claim 16, wherein the optical sensor further includes a switching element outputting one of the sensing signals, the switching element formed of a thin film transistor.

18. The display device of claim 10, wherein the light source is a light emitting diode.

19. A driving method of a display device having a light source irradiating light, the driving method comprising:
generating a plurality of sensing signals by receiving external light;
converting the plurality of sensing signals to a plurality of digital signals indicating conditions of luminance based on the plurality of sensing signals;
determining a condition of luminance corresponding to digital signals having a same value as a current condition of luminance when a number of the digital signals having the same value, among the plurality of digital signals, is more than or same as a predetermined number;
generating a luminance control signal according to the current condition of luminance; and
controlling the light source according to the luminance control signal.

20. The driving method of claim 19, further comprising:
maintaining a former condition of luminance as the current condition of luminance when the number of digital signals having the same value, among the plurality of digital signals, is less than the predetermined number.

21. The driving method of claim 19, further comprising sequentially selecting the plurality of sensing signals for every predetermined time.

22. The driving method of claim 19, wherein the digital signals have a hysteresis characteristic with respect to the sensing signals.

23. The driving method of claim 19, wherein the light source is a light emitting diode.
